(19) United States
(12) Patent Application Publication
(10) Pub. No.: US 2020/0127342 A1
(43) Pub. Date: Apr. 23, 2020

(54) THERMAL MANAGEMENT SYSTEM

(71) Applicant: Ningbo Geely Automobile Research & Development Co., Ltd., Ningbo (CN)

(72) Inventors: Christèle GRIMAUD, Goteborg (SE); Sandeep DAVID, Goteborg (SE); Bengt AXELSSON, Västra Frölunda (SE); Sri Vishnu GORANTLA NARAYANA MURTHY, Goteborg (SE)

(21) Appl. No.: 16/724,256

(22) Filed: Dec. 21, 2019

Related U.S. Application Data
(63) Continuation of application No. PCT/CN2018/092682, filed on Jun. 25, 2018.

(30) Foreign Application Priority Data
Jul. 3, 2017 (EP) 17179332.6

(51) Int. Cl. H01M 10/48; H01M 10/613; H01M 10/625; H01M 10/615

(52) U.S. Cl. CPC H01M 10/486; H01M 10/615; H01M 10/625; H01M 10/613

(57) ABSTRACT

A method performed in a thermal management device for proactive managing the temperature of a battery connected to an electronic device, the method including: obtaining a measurement of the current temperature of the battery, obtaining a value of a battery current of the battery, determining a value of the resistance of the battery, determining a predictive temperature increase of the battery at least based on the obtained value of the battery current and the determined value of the resistance, and managing the temperature of the battery at least based on the current temperature of the battery and the predictive temperature increase of the battery.

### RELATED APPLICATION DATA

This application is a continuation of International Patent Application No. PCT/CN2018/092682, filed on Jun. 25, 2018, which claims the benefit of European Patent Application No. 17179332.6, filed on Jul. 3, 2017, the disclosures of which are incorporated herein by reference in their entireties.

### TECHNICAL FIELD

The present invention relates to the field of management of the temperature in a battery.

### BACKGROUND ART

The performance and the lifetime of a battery is temperature dependent. High temperature is well known to accelerate the battery's ageing and subsequently shorten the life-time. Therefore, the battery should operate within an optimal temperature window as much as possible in order to ensure the performance and life-time. This is valid for all types of batteries and especially for high voltage battery pack used in an automotive/vehicle application.

A thermal management system is used to manage the temperature of the battery, however, there is a need for a faster and more efficient thermal control of the temperature of the battery.

### SUMMARY OF THE INVENTION

It is known in the art that a temperature of a battery is effecting the performance and the lifetime of a battery. For this reason it is known to use sensors to measure the temperature of the battery and to manage the battery based on the measured temperature.

The increase or decrease of the temperature in a battery depends on the current that is drawn from the battery and the resistance of the battery.

Aging in batteries depend on many different aspect and an effect of the aging of a battery is that the resistance of the battery increases over time. Today there is a demand and a need for a faster and more efficient thermal control of a battery.

An object of the present invention is to provide a method and a device which seek to mitigate, alleviate, or eliminate one or more of the above-identified deficiencies in the art and disadvantages singly or in any combination.

In this disclosure, a solution to the problem outlined above is proposed. In the proposed solution, a method performed in the thermal management device for proactive managing the temperature of the battery connected to the electronic device will be described. The method comprise the steps of obtaining a measurement of the current temperature Tₐ of the battery, obtaining a value of a battery current of the battery, determining a value of the resistance of the battery, determining a predictive temperature increase T_{dc} of the battery at least based on the obtained value of the battery current and the determined value of the resistance, and managing the temperature of the battery at least based on the current temperature Tₐ of the battery and the predictive temperature increase T_{dc} of the battery. By managing the temperature based on both the actual temperature Tₐ and the predictive temperature increase T_{dc} of the battery, the thermal management device can act on an upcoming increase in temperature of the battery before the actual increase has occurred. By using the predictive temperature increase T_{dc} as a feedforward value when managing the temperature T of the battery, the management can react much faster and be more efficient. Further, the temperature management device performing the method could avoid over heating of the battery and reduce damage to the battery.

According to an aspect the step of determining the resistance of the battery comprise the step of obtaining one or more of State of Charge (SoC) of the battery, State of Health (SoH) of the battery, the temperature T of the battery and the current flowing through the battery.

According to an aspect the determined value of the resistance of the battery is a real-time value of the current resistance of the battery. Put in another way, the determined value of the resistance is the resistance of the battery of the current time. The value of the resistance, thus, comprises the changes of the resistance of the battery due to aging and other thing that has been exposing the battery.

According to an aspect the predictive temperature increase T_{dc} is determined at least based on the function T_{dc} ∝I²*R.

According to an aspect the step of managing the temperature T of the battery comprise cooling the battery if the sum of the actual battery temperature Tₐ and the predictive temperature increase T_{dc} is higher than a first target temperature Tₜ₁.

According to an aspect the step of managing the temperature T of the battery comprise cooling the battery to a second target temperature Tₜ₂ if the sum of the actual battery temperature Tₐ and the predictive temperature increase T_{dc} is higher than the first target temperature Tₜ₁.

According to an aspect the step of managing the temperature T of the battery comprise heating the battery, if the sum of the actual battery temperature Tₐ and the predictive temperature increase T_{dc} is lower than a third target temperature Tₜ₃.

According to an aspect the step of managing the temperature of the battery comprise managing the thermal management device based on a temperature difference

ΔT between the sum of the current temperature Tₐ of the battery and the predictive temperature increase T_{dc} of the battery in view of at least one of the first, second and third target temperature Tₜ₁, Tₜ₂, Tₜ₃.

According to an aspect the step of managing the temperature of the battery comprise amplifying, in a proportional and/or integral and/or derivative (PID, PD, ID) controller, the temperature difference ΔT.

According to an aspect the battery is a high voltage battery. According to an aspect the electronic device is a vehicle.

According to an aspect the thermal management device is connected to an accelerator of the vehicle and the step of obtaining the value of the battery current of the battery comprise obtaining an input from the accelerator received from a driver of the vehicle.

According to an aspect the step of cooling of the battery comprise regulating a cooling unit.

According to an aspect the step of heating of the battery comprise regulating a heating unit.

According to an aspect the steps in the method are performed continuously. Put in another way, the steps in the method is repeated over and over again as long as the electronic device is active. According to an aspect the steps of the method is repeated with a pre-set time period.

According to an aspect the thermal management device is configured to perform the method according to the above.

According to an aspect the thermal management device is connected to the battery and the electronic device.

According to an aspect the electronic device is one of an electrical vehicle, a smartphone, a tablet, a portable computer and an electrical bike.

Generally, all terms used in the claims are to be interpreted according to their ordinary meaning in the technical field, unless explicitly defined otherwise herein. All references to “a/an/the [element, device, component, means, etc.]” are to be interpreted openly as referring to at least one instance of said element, device, component, means, etc., unless explicitly stated otherwise. Further, by the term “comprising” it is meant “comprising but not limited to” throughout the application.

### BRIEF DESCRIPTION OF DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments and aspects.

FIG. 1 discloses a schematic view of a thermal management device for proactive managing the temperature of a battery connected to an electronic device.

FIG. 2 disclose a schematic view of an electric vehicle comprising a thermal management device according to some aspects of the invention.

FIG. 3 illustrates a flow chart of the method steps according to some aspects of the invention.

### DETAILED DESCRIPTION

Aspects of the present disclosure will be described more fully hereinafter with reference to the accompanying figures. The assembly disclosed herein can, however, be realized in many different forms and should not be construed as being limited to the aspects set forth herein.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

The present invention relates to method performed in a thermal management device for proactive managing the temperature of a battery and to a thermal management device.

Today it is very popular to use batteries for powering all kinds of electrical devices. Not only smaller home electronic devices such as smartphones, tablets and portable computers but also electrical devices such as electrical drilling machines, electrical lawn mowers, electrical bikes and electrical vehicles/automotive make use of batteries. There are different types of batteries, and in particular, batteries that are rechargeable are commonly used.

A battery requires thermal management of the temperature of the battery to ensure plural years of utilization of the battery and to avoid that the battery gets damaged due to too high temperatures. Further, if the temperature of the battery is to low the performance of the battery could change/decrease.

Electric vehicles/automotive, from hybrids to full electric vehicles, require thermal management of the temperature of the battery to ensure plural years of utilization of the vehicle battery. The wear of the vehicle battery depends on different things that it is exposed to, for instance the driving behaviour of a vehicle driver. To prevent battery cell damage and ensure the safety of the battery, the temperature of the battery is managed to keep the temperature of the battery below a desired temperature or in a temperature window between two temperatures.

A vehicle driver with an aggressive driving behaviour will increase the temperature of the battery and the battery should be cooled. At the same time, the battery should be heated if the driver is using to low current or if the outside temperature is low.

The inventors have identified that there is a need for a solution where the temperature of the battery is proactively managed instead of a more traditionally reactive management of the temperature of a battery.

Traditionally, a thermal management system/device for managing the temperature of to battery is a closed-loop system. In this closed loop system, the thermal management system compares an actual battery temperature Tₐ with a target temperature Tₜ. The target temperature is a pre-set temperature below which temperature the battery should be kept to perform as intended/desired. Depending on these values, an error signal ΔT is obtained via the function (1).

ΔT=Tₜ−Tₐ (1)

The error signal ΔT could be amplified by a control system, such as a proportional-integral-derivative (PID) controller gain (G×ΔT), aiding the thermal management system to reach the pre-set target temperature Tₜ. This approach measures the battery temperature in real time and the thermal management system manages the temperature of the battery based on the current battery temperature Tₐ and the pre-set target temperature Tₜ. Cooling of the battery is requested only when the battery's temperature is above the pre-set target temperature Tₜ. In some cases the actual temperature is estimated by different methods, however, the cooling of the battery is requested only when the battery's temperature is above the pre-set target temperature Tₜ

The inventors have noted that the internal resistance of the battery depends on one or more of the State of Charge of the battery, State of Health of the battery, temperature of the battery and the current flowing through the battery. By accurately knowing the present/current/real-time resistance of the battery and the present/current/real-time current flowing through the battery, a predictive temperature increase due to the heat loss can be obtained by the function (2).

T_{dc}∝I²*R (2)

The predictive temperature increase T_{dc} is the temperature that the battery will increase, based on the current resistance of the battery and the current drawn from the battery, if nothing is done. There is a difference between a prediction of a future temperature of the battery and an estimation of a present temperature of the battery.

A battery that is rechargeable has a certain State of Charge, SOC. The units of State of Charge, SOC, are percentage points where 100% means fully charged battery and 0% means a fully discharged battery, i.e. a battery that is “empty”. A battery is traditionally charged to a certain State of Charge, SOC.

The so called State of Health, SOH are percentage points of the condition of a battery compared to its ideal conditions where 100% means the battery's conditions match the battery's specifications. Typically at the time of manufacture the battery's State of Health, SOH, is 100% but decreases over time and use of the battery. The State of Health, SOH, does not correspond to any particular Physical value instead different manufacturers have different ways to determine the State of Health value of a battery. There are different parameters that are being used for determining the State of Health value, in particular the battery internal resistance, the battery internal impedance, the battery internal conductance, the battery capacity, the battery voltage etc. There are also other factors that can be taken in consideration for determining the State of Health, SOH, value such as the number of times the battery has been charged/discharged and the temperatures that the battery has been exposed to.

Batteries age with reduced battery cell energy capacity due to chemical changes to the electrodes. Aging in batteries, for example in lithium ion batteries, change the resistance of the battery over time.

Further, the inventors has discovered that the electrical time constant is faster than the thermal time constant, thus, it takes time for the temperature of the battery to increase to T_{dc}. This means that an increase of the temperature of the battery can be calculated before the temperature of the battery actually has increased. Put in yet another way, the change of temperature of the battery can be determined before the actual temperature of the battery has changed. Put in yet another way, the actual temperature of the battery in a time in the future can be predicted. A thermal management device configured to manage the temperature of the battery can be made to act quickly by including this predictive temperature increase T_{dc} of the temperature as a feedforward term. By accurately designing the method performed in the thermal management device based on these aspects, a more efficient management/control/regulating of the temperature of the battery could be achieved.

The method according to the invention takes into account the internal resistance R of the battery and the predictive temperature increase T_{dc}. The feedforward term fine tunes the management by computing the difference ΔT of the actual temperature Tₐ and the predictive temperature increase T_{dc} in view of the target temperature Tₜ by the function (3).

ΔT=Tₜ−Tₐ+T_{dc} (3)

Since the temperature management device is aware of/takes into consideration the additional predictive temperature increase T_{dc}, the actions taken by the temperature management device will be faster and more efficient. Further, this also makes the method performed in the thermal management device proactive in maintaining the temperature of the battery close to an optimal temperature of the battery. The optimal temperature is according to an aspect a first target temperature Tₜ₁ which the temperature of the battery should be below. According to an aspect the temperature of the battery should be between the first target temperature Tₜ₁ and the second target temperature Tₜ₂. Put in another way, the temperature of the battery should be managed to be within a temperature window leading to an increased lifetime and performance of the battery pack. According to an aspect the temperature should be above a third target temperature Tₜ₃.

Reference is now made to FIG. 1 that illustrates a temperature management device 1 according to an aspect of the invention. The temperature management device 1 is connected to a battery 40 and an electronic device 2. The battery 40 is further connected to the electronic device 2 and configured to power the electronic device 2. According to an aspect further batteries could be connected to the electronic device 2 and or temperature management device 1.

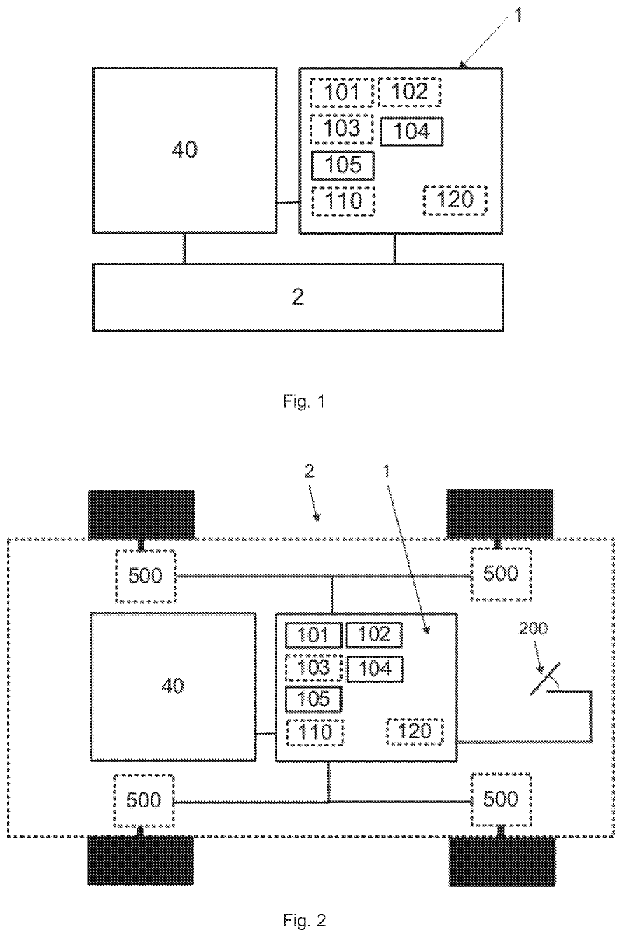

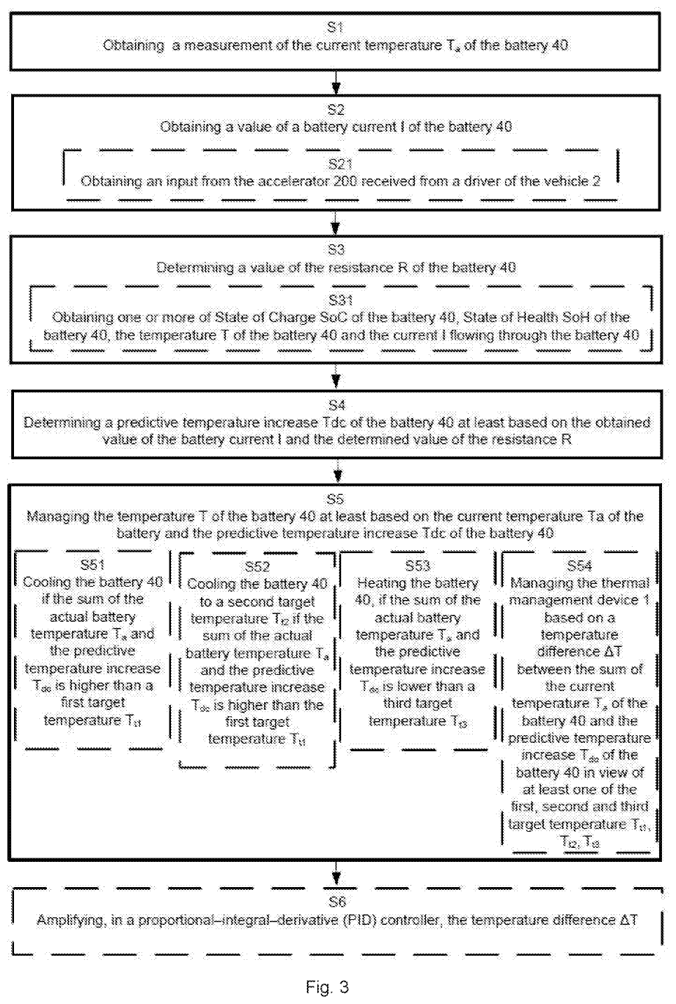

The temperature management device 1 comprises a memory 101 and a processing circuitry 102. According to an aspect, the temperature management device 1 further comprise at least one of a user interface unit 103, a measurement unit 110 and a control unit 120. The user interface unit 103 is typically configured for input and output of information from/to a user of the electronic device 2. In an aspect of a vehicle, as disclosed in FIG. 2, the user can be the driver of the vehicle. According to an aspect the user interface 103 is used to set one or more of the target temperatures Tₜ₁, Tₜ₂, Tₜ₃. In one example the user interface unit 103 is a touch sensitive display but can be any input/output device. According to an aspect the temperature management device 1 comprise a cooling unit 104. The cooling unit 104 is connected to the battery and arranged to cool the battery 40 to lower the actual temperature Tₐ of the battery 40. According to an aspect the cooling unit 104 is arranged to cool the battery to prevent a predictive temperature increase T_{dc} of the battery. According to an aspect the temperature management device 1 comprise a heating unit 105. The heating unit 105 is connected to the battery 40 and arranged to heat the battery 40 to increase the actual temperature Tₐ of the battery 40. According to an aspect the heating unit 105 is arranged to heat the battery 40 to prevent a predictive negative temperature increase T_{dc} of the battery 40 below the target temperature Tₜ₃.

According to an aspect the memory 101 is a Random-access Memory, RAM; a

Flash memory; a hard disk; or any storage medium that can be electrically erased and reprogrammed. According to an aspect the processing circuitry 102 is a Central Processing Unit, CPU, or any processing unit carrying out instructions of a computer program or operating system.

According to an aspect, as disclosed in FIG. 2, the electronic device 2 is a vehicle 2, e.g. a hybrid vehicle or fully electric vehicle, according to some aspects of the invention. The vehicle 2 comprises the battery 40 connected to the temperature management unit 1. The vehicle 2 further comprise a electrical motors 500 that are in connection with the battery 40 and being used for driving the vehicle 2.

According to an aspect the vehicle 2 comprise an accelerator 200 connected to the battery. The power form the battery 40 needed for powering the motors 500 is regulated by the accelerator 200. A driver requiring a fast acceleration and/or fast speed of the vehicle 400 will demand the battery 40 to deliver more power to the electrical motors 500.

According to an aspect the thermal management device 1 detects and obtains different measurements of values and/or values of the battery 40. According to an aspect the measurement unit 110 of the thermal management device 1 obtains the measurements of values and/or the values of the battery 40. According to an aspect one or more sensors in, or connected to, the thermal management device 1 and the battery 40, detects and obtains the values of the battery.

According to an aspect the measurements of values and/or the value of the battery is one or more of the State of Charge SoC of the battery, State of Health SoH of the battery 40, the actual temperature Tₜ of the battery 40, the resistance R of the battery, the battery capacity, the battery internal impedance voltage value of the battery 40 and the current I flowing through the battery 40. The values can be the actual value of the parameters or a value corresponding/relating to the actual value of the parameter. According to an aspect the measurements of values and/or the value of the battery is processed by the processing circuitry 102 and stored in the memory 101 of the thermal management device 1.

According to an aspect a State of Health value can be determined by first measuring a value by the measurement unit 110, the value corresponding to at least one of the battery capacity or the battery internal impedance.

According to an aspect the voltage value is used as an input parameter value for determining the State of Charge value of the battery 40. According to an aspect data from a known discharge function, or curve, of the battery 40 together with the voltage value is used in order to determine the State of Charge value of the battery 40.

According to an aspect the measurement unit 110 is configured to obtain measurement data related to one or more of the voltage, impedance, resistance, current, heat, pressure, gravity, pH and other data relating to the State of Charge, SOC and/or State of Health, SOH, of the battery 40. According to an aspect at least one of any known methods such as chemical method, voltage method, current integration method, Kalman filtering or pressure method is applied in order to obtain a State of Charge value.

The processing circuitry 102 is configured to cause the thermal management device 1 to obtain a measurement of the current temperature Tₐ of the battery, obtain a value of the battery current I of the battery. Further the thermal management device 1 is configured to obtain measurements to determining a value of the resistance R of the battery. The thermal management device 1 is configured to determine the predictive temperature increase T_{dc} of the battery 40 at least based on the obtained value of the battery current I and the determined value of the resistance R. According to an aspect the predictive temperature increase T_{dc} is determined by using the function

T_{dc}∝I²*R (2).

The thermal management device 1 thereafter controls/manage/regulates the temperature of the battery 40 at least based on the values of the current temperature Tₐ of the battery 40 and the predictive temperature increase T_{dc} of the battery 40.

Hereafter a method performed in the thermal management device 1 for proactive managing the temperature of the battery 40 connected to the electronic device 2 will be described. The method comprise the steps of obtaining S1 a measurement of the current temperature Tₐ of the battery 40, obtaining S2 a value of a battery current I of the battery 40, determining S3 a value of the resistance R of the battery 40, determining S4 a predictive temperature increase T_{dc} of the battery 40 at least based on the obtained value of the battery current I and the determined value of the resistance R, and managing S5 the temperature T of the battery 40 at least based on the current temperature Tₐ of the battery and the predictive temperature increase T_{dc} of the battery

40. By managing S5 the temperature based on both the actual temperature Tₐ and the predictive temperature increase T_{dc} of the battery 40, the thermal management device 1 can act on an upcoming increase in temperature of the battery 40 before the actual increase has occurred. By using the predictive temperature increase T_{dc} as a feedforward value when managing the temperature T of the battery 40, the method in the thermal management device 1 can react much faster and be more efficient. Further, the temperature management device 1 performing the method could avoid over heating of the battery 40 and reduce the risk of damaging the battery.

According to an aspect the step of determining S3 the resistance R of the battery 40 comprise the step of obtaining S31 one or more of the State of Charge (SoC) of the battery 40, the State of Health (SoH) of the battery 40, the temperature T of the battery 40 and the current I flowing through the battery 40.

According to an aspect the determined S3 value of the resistance R of the battery 40 is a real-time value of the current resistance R of the battery 40. Put in another way, the determined value of the resistance R is the resistance of the battery at the current time. The value of the resistance R, thus, comprises and takes into consideration the changes of the resistance R of the battery 40 due to aging and other things that has effected the battery.

According to an aspect the predictive temperature increase T_{dc} is determined S4 at least based on the function T_{dc} ∝I²*R.

According to an aspect the step of managing S5 the temperature T of the battery 40 comprise cooling S51 the battery 40 if the sum of the actual battery temperature Tₐ and the predictive temperature increase T_{dc} is higher than a first target temperature Tₜ₁. Put in another way, the temperature of the battery 40 is kept below the first target temperature Tₜ₁.

According to an aspect the step of managing S5 the temperature T of the battery 40 comprise cooling S52 the battery 40 to a second target temperature Tₜ₂ if the sum of the actual battery temperature Tₐ and the predictive temperature increase T_{dc} is higher than the first target temperature Tₜ₁. According to an aspect the step of managing S5 the temperature of the battery 40 comprise cooling the battery 40 to keep the temperature of the battery 40 between the first target temperature Tₜ₁ and the second target temperature Tₜ₂.

According to an aspect the step of managing S5 the temperature T of the battery 40 comprise heating S53 the battery 40, if the sum of the actual battery temperature Tₐ and the predictive temperature increase T_{dc} is lower than a third target temperature Tₜ₃.

According to an aspect the step of managing S5 the temperature of the battery 40 comprise managing S54 the thermal management device 1 based on the temperature difference ΔT between the sum of the current temperature Tₐ of the battery 40 and the predictive temperature increase T_{dc} of the battery 40 in view of at least one of the first, second and third target temperature Tₜ₁, Tₜ₂, Tₜ₃.

According to an aspect the step of managing S5 the temperature of the battery comprise amplifying S6, in a proportional and/or integral and/or derivative (PID, PD, ID) controller, the temperature difference ΔT. According to an aspect the step of managing S5 the temperature of the battery comprise amplifying S6, in a control system, the temperature difference ΔT.

According to an aspect the electronic device 2 is a vehicle 2.

According to an aspect the thermal management device 1 is connected to an accelerator 200 of the vehicle 2 and the step of obtaining S2 the value of the battery current I of the battery 40 comprise obtaining S21 an input from the accelerator 200 received from a driver of the vehicle 2.

According to an aspect the step of a cooling S51 of the battery 40 comprise regulating S55 a cooling unit 104.

According to an aspect the step of a heating S53 of the battery 40 comprise regulating S56 a heating unit 105.

According to an aspect the steps in the method are performed continuously. Put in another way, the steps in the method is repeated over and over again as long as the electronic device 2 is active. According to an aspect the steps of the method is repeated with a pre-set time period. According to an aspect the sampling time that the method is repeated by depends on the thermal time constant and the electrical time constant (i.e. dependent on the current flowing through the battery due to the driving behavior). The thermal time constant is according to an aspect very high compared to the electrical time constant and the sampling time could be designed based on the application.

According to an aspect the thermal management device 1 is configured to perform the method according to the above.

According to an aspect the thermal management device 1 is connected to the battery 40 and the electronic device 2.

According to an aspect the electronic device 2 is one of an electrical vehicle, a smartphone, a tablet, a portable computer and an electrical bike. According to an aspect the electronic device 2 is a vehicle 2.

An example of how an aspect of the invention could work in practice is that the thermal management device 1 is connected to an accelerator 200 of a vehicle 2 and the step of obtaining S2 the value of the battery current I of the battery 40 comprise obtaining S21 an input from the accelerator 200 received from a driver of the vehicle 2. As the vehicle 2 approaches a steep hill, the user push down the accelerator 200 of the vehicle 2 to maintain the speed of the vehicle 2 in the inclination. When the accelerator 200 is pressed down, the current I drawn from the battery 40 increases. If nothing is done, the temperature of the battery 40 will increase after a period of time as a consequence of that the increased current I will heat the battery 40. However, with the present thermal management device 1 the cooling of the battery 40 is initiated directly based on that the accelerator is pushed down. The thermal management device 1 is able to predict a future temperature increase and to act on that information and cool the battery 40 before it has reached the predicted temperature. This will be a more effective way of regulating the temperature of the battery than to estimate or predict a present temperature of the battery and act on that input once a temperature is reached.

Another example is that when a vehicle 2 is driven in a city at a low speed and at a gentle flow and thereafter approaches and drives out on a high way. The user then rapidly increases the current I drawn from the battery 40 as the accelerator is pushed down and, if nothing is done, the temperature of the battery 40 is increased after a period of time. However, the thermal management device 1 will be able to predict a future temperature increase and to act on that information and cool the battery 40 before it has reached the predicted temperature. The thermal management device 1 is using predictive future temperatures of the battery and thereafter uses this information to avoid that the predictive future temperature is actually met.

According to an aspect of the invention further proposes a computer program comprising computer-readable code which, when executed by the processing circuitry 102 of the electronic device 2, causes the thermal management device 1 to perform the method. Hence the code can be reproduced and run on plural different electronic devices 2 to perform the method. According to an aspect the method is carried out by instructions in a computer program that is downloaded and run on the thermal management device 1. According to an aspect the computer program is a so called app. The app can according to an aspect generate a user interface for user interaction via a user interface unit 103 of a second electronic device. The disclosure further proposes a computer program product comprising a non-transitory memory storing a computer program. Hence, the memory can maintain the code so that the method can be executed at any later stage.

The person skilled in the art realizes that the present invention by no means is limited to the preferred embodiments described above. On the contrary, many modifications and variations are possible within the scope of the appended claims.

The description of the aspects of the disclosure provided herein has been presented for purposes of illustration. The description is not intended to be exhaustive or to limit aspects of the disclosure to the precise form disclosed, and modifications and variations are possible in light of the above teachings or may be acquired from practice of various alternatives to the provided aspects of the disclosure. The examples discussed herein were chosen and described in order to explain the principles and the nature of various aspects of the disclosure and its practical application to enable one skilled in the art to utilize the aspects of the disclosure in various manners and with various modifications as are suited to the particular use contemplated. The features of the aspects of the disclosure described herein may be combined in all possible combinations of methods, apparatus, modules, systems, and computer program products. It should be appreciated that the aspects of the disclosure presented herein may be practiced in any combination with each other.

It should be noted that the word “comprising” does not necessarily exclude the presence of other elements or steps than those listed. It should further be noted that any reference signs do not limit the scope of the claims.

What is claimed is:

1. A method performed in a thermal management device for proactive managing the temperature of a battery connected to an electronic device, the method comprising:
obtaining a measurement of the current temperature of the battery,
obtaining a value of a battery current of the battery,
determining a value of the resistance of the battery,
determining a predictive temperature increase of the battery at least based on the obtained value of the battery current (I) and the determined value of the resistance, and
managing the temperature of the battery at least based on the current temperature of the battery and the predictive temperature increase of the battery.

2. The method according to claim 1, wherein the step of determining the resistance of the battery comprise the step of obtaining one or more of State of Charge (SoC) of the battery, State of Health (SoH) of the battery, the temperature of the battery and the current flowing through the battery.

3. The method according to claim 1, wherein the determined value of the resistance of the battery is a real-time value of the current resistance of the battery.

4. The method according to claim 1, wherein the predictive temperature increase is determined at least based on the function T_{dc} ∝I²*R.

5. The method according to claim 1, wherein the step of managing the temperature of the battery comprise cooling the battery if the sum of the actual battery temperature and the predictive temperature increase is higher than a first target temperature.

6. The method according to claim 1, wherein the step of managing the temperature of the battery comprise cooling the battery to a second target temperature if the sum of the actual battery temperature and the predictive temperature increase is higher than the first target temperature.

7. The method according to claim 1, wherein the step of managing the temperature of the battery comprise heating the battery, if the sum of the actual battery temperature and the predictive temperature increase is lower than a third target temperature.

8. The method according to claim 1, wherein the step of managing the temperature of the battery comprise managing the thermal management device based on a temperature difference between the sum of the current temperature of the battery and the predictive temperature increase of the battery in view of at least one of the first, second and third target temperature.

9. The method according to claim 1, wherein the thermal management device is connected to an accelerator of a vehicle and the step of obtaining the value of the battery current of the battery comprise obtaining an input from the accelerator received from a driver of the vehicle.

10. The method according to claim 5, wherein the step of cooling of the battery comprise regulating a cooling unit.

11. The method according to claim 6, wherein the step of heating of the battery comprise regulating a heating unit.

12. The method according to claim 1, wherein the steps are performed continuously.

13. A thermal management device for proactive managing a temperature of a battery connected to an electronic device, configured to perform the method according to claim 1.

14. The thermal management device according to claim 13, wherein the thermal management device is connected to the battery and the electronic device.

15. The thermal management device according to claim 13, wherein the electronic device is one of an electrical vehicle, a smartphone, a tablet, a portable computer and an electrical bike.
